(19) United States
(12) Patent Application Publication
(10) Pub. No.: US 2025/0237740 A1
(43) Pub. Date: Jul. 24, 2025

(54) ANGULAR ERROR ESTIMATION DEVICE AND ANGULAR ERROR ESTIMATION METHOD

(71) Applicant: DENSO CORPORATION, Kariya-city (JP)

(72) Inventor: Takuya TAKAYAMA, Kariya-city (JP)

(21) Appl. No.: 19/175,481

(22) Filed: Apr. 10, 2025

Related U.S. Application Data
(63) Continuation of application No. PCT/JP2023/036200, filed on Oct. 4, 2023.

(30) Foreign Application Priority Data
Oct. 11, 2022 (JP) 2022-163258

(51) Int. Cl. G01S 7/40; G01S 13/44; G01S 13/931

(52) U.S. Cl. CPC G01S 7/403; G01S 13/4418; G01S 13/931; G01S 2013/93275

(57) ABSTRACT

An angular error estimation device calculates, for detected stationary objects, a moving direction indication value indicating a moving direction of a stationary object viewed from a movable body assuming that the movable body is traveling in a straight line, for each observation angle at which a radar device has observed the stationary object, based on object detection information and movement locus information. The device classifies moving direction indication values for each observation angle and calculates, as a moving direction average value, an average value of the moving direction indication values classified by the observation angle for each observation angle. The device calculates the angular error for each observation angle based on an average movement locus calculated based on the moving direction average values for each observation angle and a reference movement locus set as a movement locus of the stationary object in a case where there is no angular error.

### CROSS-REFERENCE TO RELATED APPLICATION

The present application is based on and claims the benefit of priority from earlier Japanese Patent Application No. 2022-163258 filed on Oct. 11, 2022, the description of which is incorporated herein by reference.

### BACKGROUND

### Technical Field

The present disclosure relates to an angular error estimation device and an angular error estimation method that estimate an angular error of a radar device.

### Related Art

A technique is disclosed in which when a vehicle is traveling, a radar device installed in a vehicle detects horizontal angles and relative speeds of a stationary object present in the vicinity of the vehicle and sets displacements from an ideal curve as errors of the horizontal angles, thereby estimating an angular error of each of the plurality of horizontal angles.

### SUMMARY

An aspect of the present disclosure provides an angular error estimation device that estimates an angular error that is an error of an azimuth angle detected by at least one radar device installed in a movable body.

The angular error estimation device includes:
a first information acquisition unit configured to acquire object detection information including at least position information indicating a position of an object present in the vicinity of the movable body, from the at least one radar device, including a lateral side of the movable body as an object detection area;
a second information acquisition unit configured to acquire movement locus information for specifying a movement locus of the movable body;
a stationary object detection unit configured to detect a stationary object that is at rest, and located at a lateral side of the movable body, based on the object detection information;
a moving direction calculation unit configured to calculate, for each of a plurality of stationary objects detected by the stationary object detection unit, a moving direction indication value indicating a moving direction of the stationary object viewed from the movable body assuming that the movable body is traveling in a straight line, for each observation angle at which the at least one radar device has observed the stationary object, based on the object detection information and the movement locus information;
an average calculation unit configured to classify a plurality of moving direction indication values calculated by the moving direction calculation unit for each observation angle and calculate, as a moving direction average value, an average value of the plurality of moving direction indication values classified by the observation angle for each observation angle; and
an angular error calculation unit configured to calculate the angular error for each of the observation angles based on an average movement locus calculated based on the plurality of moving direction average values for each of the observation angles and a reference movement locus set as a movement locus of the stationary object in a case in which there is no angular error.

### BRIEF DESCRIPTION OF THE DRAWINGS

In the accompanying drawings:

FIG. 1 is a block diagram illustrating a configuration of a vehicular information provision device;

FIG. 2 is a diagram illustrating an installation position of a radar device and an object detection area;

FIG. 3 is a diagram illustrating a left side object detection area, a rear side object detection area, and a right side object detection area;

FIG. 4 is a diagram for describing a principle of calculating an angular correction amount;

FIG. 5 is a flowchart of a gradient calculation process;

FIG. 6 is a diagram for describing a method of determining whether there is a stationary object;

FIG. 7 is a diagram for describing a method of calculating a gradient of the stationary object;

FIG. 8 is a diagram for describing coordinate transformation of an observation angle;

FIG. 9 is a diagram for describing a component of a movement locus of the stationary object added by turning;

FIG. 10 is a flowchart of an angular correction process according to a first embodiment;

FIG. 11 is a graph illustrating an average value of gradients of the stationary object at each observation angle and a graph illustrating the number of observations at each observation angle;

FIG. 12 is a diagram for describing a fundamental principle of an angular error calculation process;

FIG. 13 is a flowchart of the angular error calculation process;

FIG. 14 is a diagram for describing a method of calculating a radial distance;

FIG. 15 is a graph illustrating an angular error at each observation angle;

FIG. 16 is a diagram illustrating a radar observation angle;

FIG. 17 is a graph illustrating a relationship between a radar observation angle and an angular error;

FIG. 18 is a flowchart of a vehicular information provision process; and

FIG. 19 is a flowchart of an angular correction process according to a second embodiment.

### DETAILED DESCRIPTION OF THE PREFERRED EMBODIMENTS

US2015/0070207A1 describes a technique in which, when a vehicle is traveling, a radar device installed in a vehicle detects horizontal angles and relative speeds of a stationary object present in the vicinity of the vehicle and sets displacements from an ideal curve as errors of the horizontal angles, thereby estimating an angular error of each of the plurality of horizontal angles.

Detailed studies by the inventor found a problem that according to the technique described in US2015/0070207A1, as the vehicle recedes from the stationary object after the vehicle passes the lateral side of the stationary object, change in speed with respect to change in the horizontal angle becomes small, whereby accuracy in estimating an angular error becomes reduced.

The present disclosure improves accuracy in estimating an angular error of a radar device.

### First Embodiment

Hereinafter, a first embodiment of the present disclosure will be described with reference to the drawings.

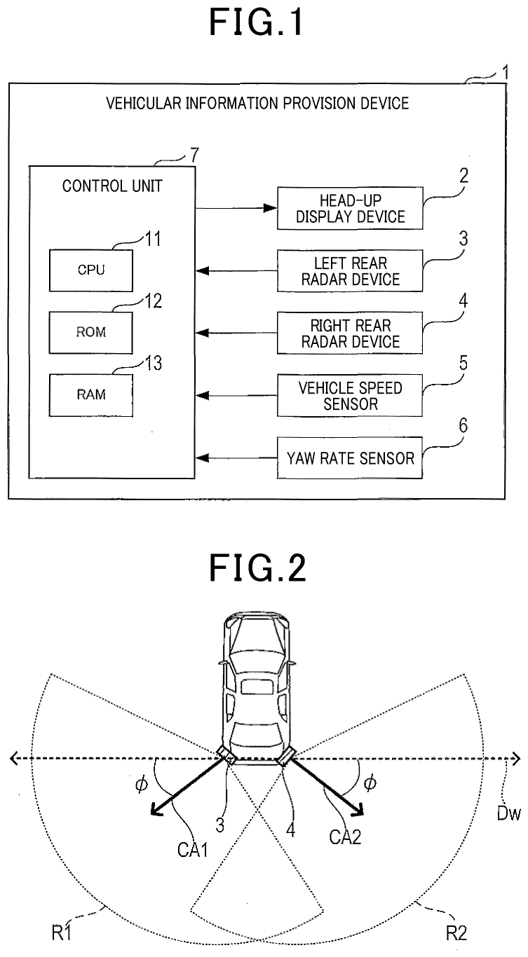

A vehicular information provision device 1 of the present embodiment is illustrated in a vehicle, and includes, as illustrated in FIG. 1, a head-up display device 2, a left rear radar device 3, a right rear radar device 4, a vehicle speed sensor 5, a yaw rate sensor 6, and a control unit 7. Hereinafter, the vehicle in which the vehicular information provision device 1 is installed is referred to as an own vehicle.

The head-up display device 2 emits display light for displaying an image from below a windshield toward the windshield. Hence, a driver can visually recognize the projected virtual image superposed on an actual view in front of the vehicle.

The left rear radar device 3 and the right rear radar device 4 transmit radar waves toward areas around the own vehicle and receive reflected radar waves. Hereinafter, the left rear radar device 3 and the right rear radar device 4 are also referred to as a radar device 3 and a radar device 4, respectively. The left rear radar device 3 and the right rear radar device 4 are disposed at the left rear end of the own vehicle and the right rear end of the own vehicle, respectively.

The radar devices 3, 4 employ, for example, a well-known FMCW method, and alternately transmit radar waves in an upsweep modulation section and radar waves in a downsweep modulation section at preset modulation periods T and receive reflected radar waves. Hence, the radar devices 3, 4 detect a distance (hereinafter, observation point distance) to a point at which the radar waves are reflected (hereinafter, observation point), a relative speed with respect to the observation point (hereinafter, observation point relative speed), and an azimuth angle at which the observation point is present (hereinafter, observation point azimuth angle). In addition, the radar devices 3, 4 output observation point information indicating the detected observation point distance, observation point relative speed, observation point azimuth angle of the observation point, to the control unit 7.

The vehicle speed sensor 5 detects a travelling speed v of the own vehicle and outputs a travelling speed detection signal indicating the detection result. The yaw rate sensor 6 detects a yaw rate ω of the own vehicle and outputs a yaw rate detection signal indicating the detection result.

The control unit 7 is an electronic control unit mainly configured by a microcomputer including a CPU 11, a ROM 12, a RAM 13, and the like. Various functions of the microcomputer are implemented by the CPU 11 executing a program stored in a non-transitory tangible storage medium. In this example, the ROM 12 corresponds to the non-transitory tangible storage medium storing the program. In addition, executing the program performs a method corresponding to the program. It is noted that some or all of the functions performed by the CPU 11 may be configured by hardware using one or more ICs and the like. In addition, the number of the microcomputers configuring the control unit 7 is optional.

The control unit 7 performs various processes based on inputs received from the radar devices 3, 4, the vehicle speed sensor 5, and the yaw rate sensor 6 to control the head-up display device 2. Specifically, the control unit 7 determines whether the vehicles present in adjacent lanes on the left side and the right side of the own vehicle are approaching from behind the own vehicle, based on the detection results of the radar devices 3, 4, the vehicle speed sensor 5, and the yaw rate sensor 6. If a vehicle is approaching, the control unit 7 causes the head-up display device 2 to display a warning image indicating that a vehicle is approaching from the rear left or the rear right.

As illustrated in FIG. 2, the left rear radar device 3 is disposed inside a bumper at the rear left of the own vehicle. The left rear radar device 3 transmits radar waves backward from the own vehicle to detect a nearby vehicle present in an object detection area R1.

The right rear radar device 4 is disposed inside the bumper at the rear right of the own vehicle. The right rear radar device 4 transmits radar waves backward from the own vehicle to detect a nearby vehicle present in an object detection area R2.

The left rear radar device 3 is mounted so that the central axis CA1 of the object detection area R1 is directed in the direction inclined a mounting angle ϕ toward the rear left with respect to the width direction Dw of the own vehicle. The right rear radar device 4 is mounted so that the central axis CA2 of the object detection area R2 is directed in the direction inclined the mounting angle ϕ toward the rear right with respect to the width direction Dw of the own vehicle.

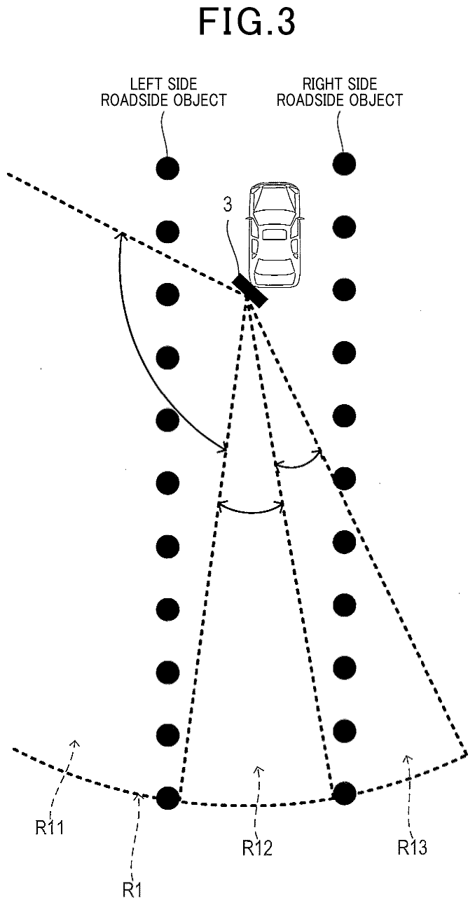

As illustrated in FIG. 3, the object detection area R1 includes a left side object detection area R11 from which an object present in the left lateral direction from the own vehicle is detected, a rear side object detection area R12 from which an object present in a directly rearward direction from the own vehicle is detected, and a right side object detection area R13 from which an object present in the right lateral direction from the own vehicle is detected. The object detection area R2 includes, as in the object detection area R1, the left side object detection area R11, the rear side object detection area R12, and the right side object detection area R13.

First, a principle of calculating an angular error in the radar devices 3, 4 will be described.

Since the radar devices 3, 4 are disposed inside the bumper as described above, radar waves emitted from the radar devices 3, 4 are transmitted to the outside of the vehicle through the bumper. If the surface of the bumper is curved, since the radar waves are refracted by the bumper, the transmission direction and the reception direction of the radar waves are displaced from each other, whereby an angular error is generated between the azimuth angle at which an object is present and the observation point azimuth angle detected by the radar devices 3, 4.

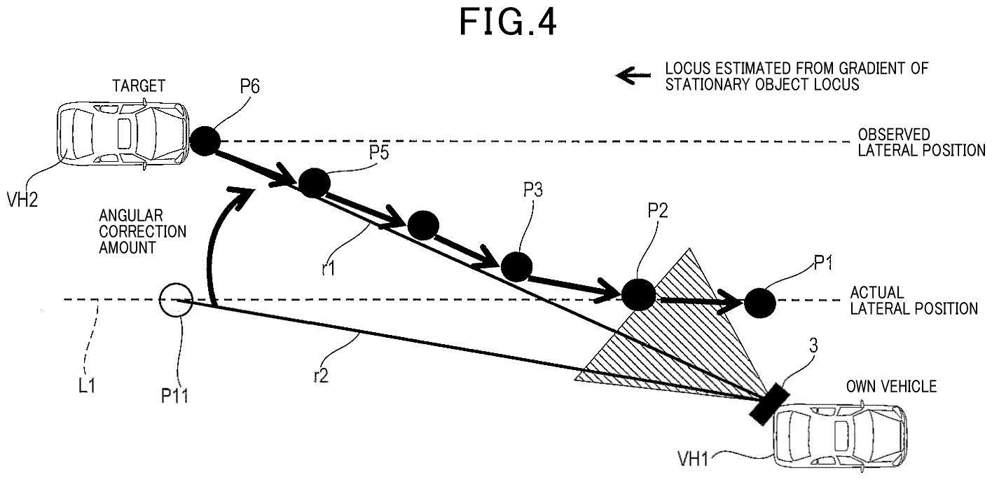

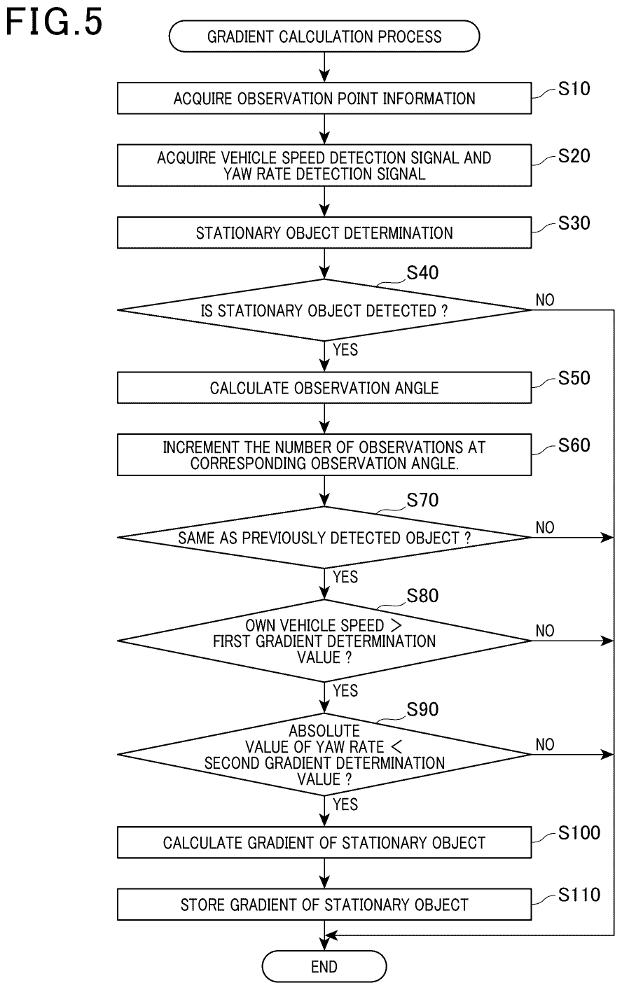

As illustrated in FIG. 4, it is assumed that an own vehicle VH1 traveling in a straight line passes the right side of a vehicle VH2 at rest (hereinafter, stationary vehicle VH2). In this case, a movement locus of the stationary vehicle VH2 is a straight line as indicated by a broken line L1.

Then, it is assumed that the left rear radar device 3 has detected a plurality of observation points P1, P2, P3, P4, P5, P6 due to the vehicle VH2 with the lapse of time.

When an angular error has been generated, as the own vehicle VH1 recedes from the stationary vehicle VH2, the difference between a lateral position of an observation point of the stationary vehicle VH2 detected by the left rear radar device 3 and an actual lateral position of the stationary vehicle VH2 increases.

It is assumed that the observation point P1 is a position observed when the own vehicle VH1 has passed just beside the stationary vehicle VH2 and that a lateral position of the observation point P1 is an actual lateral position of the stationary vehicle VH2.

Assuming the situation to be as described above, the actual lateral position of the stationary vehicle VH2 at a time point at which the observation point P6 is detected is determined so that, as indicated by a position P11, a distance r1 and a distance r2 are equal to each other, and the position P11 is located on the broken line L1. The distance r1 is a distance between the observation point P6 and the radar device 3. The distance r2 is a distance between the position P11 and the radar device 3.

Hence, the difference between the azimuth angle of the position P11 and the azimuth angle of the observation point P6 is calculated as an angular correction amount.

Next, a procedure of a gradient calculation process performed by the control unit 7 will be described. The gradient calculation process is performed every time the modulation period T has passed while the control unit 7 operates.

When the gradient calculation process is performed, as illustrated in FIG. 5, first in step S10, the CPU 11 of the control unit 7 acquires observation point information from the radar devices 3, 4.

In step S20, the CPU 11 acquires a travelling speed detection signal from the vehicle speed sensor 5 and acquires a yaw rate detection signal from the yaw rate sensor 6.

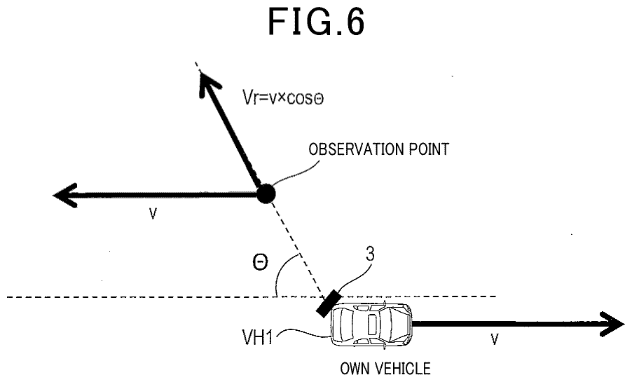

In step S30, the CPU 11 determines whether an observation point corresponding to the observation point information acquired in step S10 is a reflection point on a stationary object. Specifically, as illustrated in FIG. 6, if the absolute value of (Vr−v*cosθ) is about 0, where the observation point relative speed is Vr, the travelling speed of the own vehicle is v, and an angle between the direction of a straight line connecting the observation point and the radar device 3 or the radar device 4, and the travelling direction of the own vehicle is θ, the CPU 11 determines that the observation point is a reflection point on the stationary object.

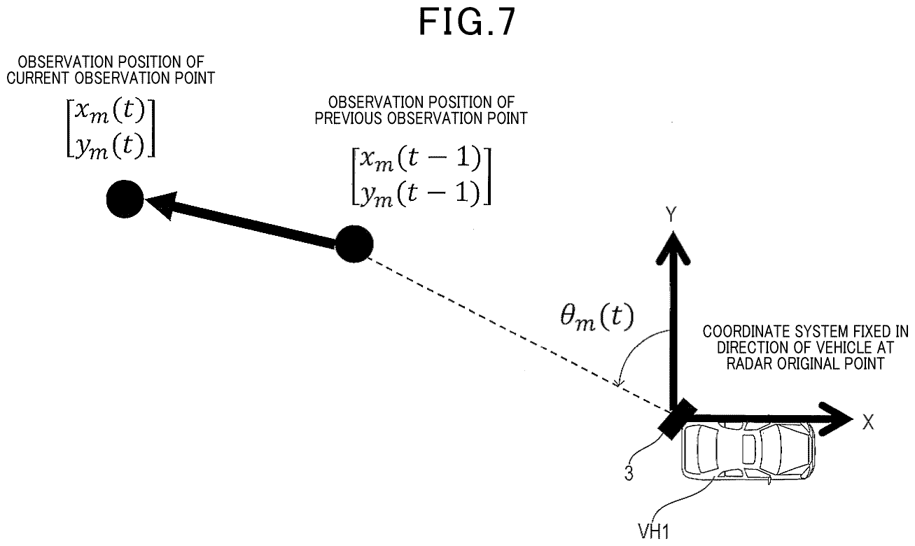

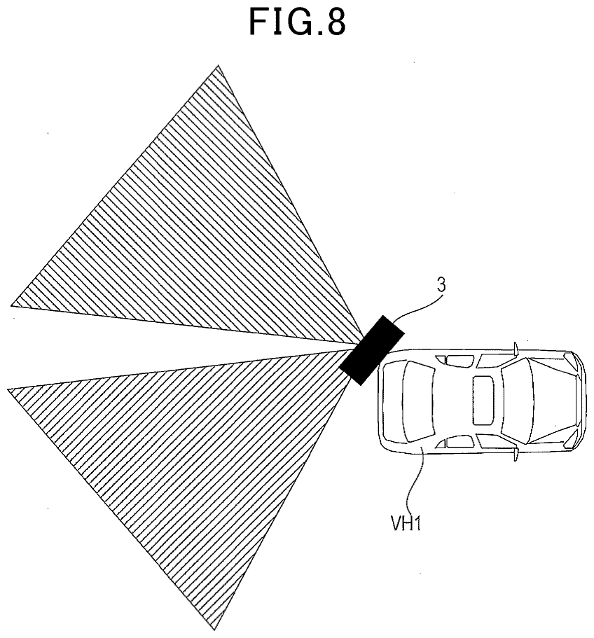

As illustrated in FIG. 5, in step S40, the CPU 11 determines whether the radar devices 3, 4 have detected a stationary object, based on the determination result of step S30. If no stationary object has been detected, the CPU 11 terminates the gradient calculation process. In contrast, if a stationary object has been detected, in step S50, the CPU 11 calculates an observation angle θₘ at the observation point corresponding to the observation point information acquired in step S10. As illustrated in FIG. 7, the observation angle θₘ is an angle that is positive in the anticlockwise in a state in which an exactly lateral direction from the own vehicle is 0°. It is noted that, to achieve commonality of functions, as illustrated in FIG. 8, the CPU 11 performs coordinate transformation for the observation point of the stationary object detected by the radar device 4, as in the data detected by the radar device 3, to calculate the observation angle θₘ and stores it in the RAM 13.

As illustrated in FIG. 5, in step S60, the CPU 11 increments (i.e., adds 1 to) the number of observations at the corresponding observation angle. It is noted that the numbers of observations at observation angles are provided for each of the radar devices 3, 4. In the present embodiment, for the observation angles of 0°, 1°, 2°, 3°, . . . , 170°, and 180°, the numbers of observations are respectively set.

In step S70, the CPU 11 determines whether the observation point corresponding to the currently acquired observation point information (hereinafter, current observation point) indicates the same object indicated by the observation point corresponding to the previously (i.e., modulation period T before) acquired observation point information (hereinafter, previous observation point).

Specifically, the CPU 11 calculates a predicted position and a predicted speed of the current observation point corresponding to the previous observation point based on the previously acquired observation point information. If respective differences between the predicted position and the predicted speed, and the observation position and the observation speed of the current observation point are smaller than a preset maximum position difference and a preset maximum speed difference, the CPU 11 determines that the current observation point indicates the same object as that indicated by the previous observation point.

If the current observation point does not indicate the same object as that indicated by the previous observation point, the CPU 11 terminates the gradient calculation process. In contrast, if the current observation point indicates the same object as that indicated by the previous observation point, in step S80, the CPU 11 determines whether the travelling speed v of the own vehicle has exceeded a preset first gradient determination value.

If the travelling speed v of the own vehicle is the first gradient determination value or lower, the CPU 11 terminates the gradient calculation process. If the travelling speed v of the own vehicle is higher than the first gradient determination value, in step S80, the CPU 11 determines whether the absolute value of the yaw rate ω of the own vehicle is smaller than a preset second gradient determination value. If the absolute value of the yaw rate ω of the own vehicle is the second gradient determination value or larger, the CPU 11 terminates the gradient determination value.

In contrast, if the absolute value of the yaw rate ω of the own vehicle is smaller than the second gradient determination value, in step S100, the CPU 11 calculates a gradient of a stationary object.

As illustrated in FIG. 7, in a coordinate system in which the radar device 3 is set as an original point, the traveling direction of the own vehicle is set as an X direction, and the direction perpendicular to the traveling direction is set as a Y direction, an X direction component of an observation position of a previous observation point is set as xₘ(t−1), a Y direction component of the observation position of the previous observation point is set as yₘ(t−1), an X direction component of an observation position of a current observation point is set as xₘ(t), and a Y direction component of the observation position of the current observation point is set as yₘ(t). Time t is the timing at which a current gradient calculation process is performed. Time (t−1) is the timing at which a previous gradient calculation process is performed. In addition, an X direction component and a Y direction component of a movement locus of a stationary object added by turning of the own vehicle are respectively set as Δx and Δy.

In this case, the CPU 11 sets the observation angle θₘ at the previous observation point as an observation angle θₘ(t) and calculates a gradient of the stationary object at the observation angle θₘ(t) using expression (1).

$$Gradient at θ m ( t ) = \frac{{y}_{m} ( t ) - {y}_{m} ( t - 1 ) - Δ y}{{x}_{m} ( t ) - {x}_{m} ( t - 1 ) - Δ x} \qquad ( 1 )$$

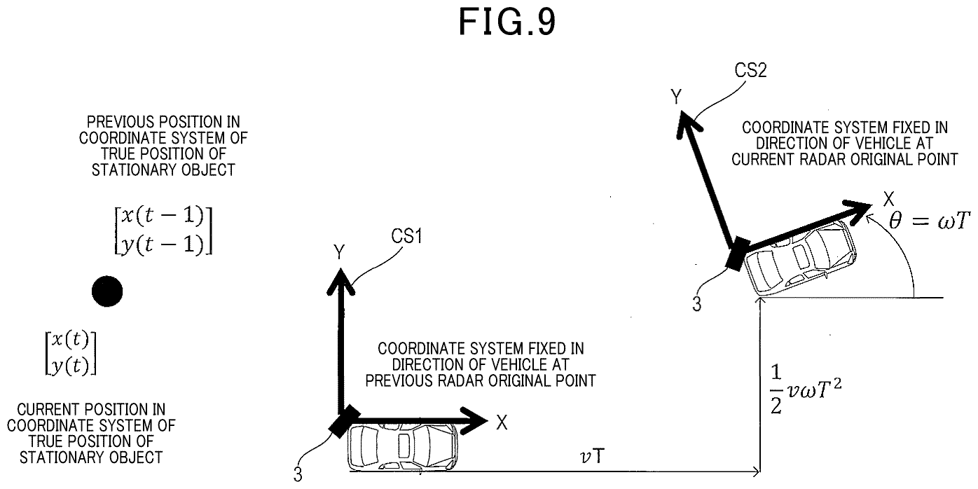

As illustrated in FIG. 9, it is assumed that, between time (t−1) and time t, the own vehicle has traveled at travelling speed v and has turned at a yaw rate ω. In this case, the own vehicle travels a distance corresponding to v*T along the traveling direction at time (t−1) and travels a distance corresponding to v*ω*T²/2 along the direction perpendicular to the traveling direction at time (t−1). Furthermore, the own vehicle turns in the horizontal direction at an angle corresponding to ω*T.

At time (t−1), a coordinate system in which the radar device 3 is set as an original point, the traveling direction of the own vehicle is set as an X direction, and the direction perpendicular to the traveling direction is set as a Y direction is set as a coordinate system CS1. At time t, a coordinate system in which the radar device 3 is set as an original point, the traveling direction of the own vehicle is set as an X direction, and the direction perpendicular to the traveling direction is set as a Y direction is set as a coordinate system CS2.

If the X direction component and the Y direction component of a position of a stationary object in the coordinate system CS1 are respectively set as x(t−1) and y(t−1) and the X direction component and the Y direction component of the position of the stationary object in the coordinate system CS2 are respectively set as x(t) and y(t), expressions (2) and (3) are established. In expression (2), ω*T*y(t) corresponds to Δx. In expression (3), the right side corresponds to Δy.

$$x ( t ) - x ( t - 1 ) = - vT + {\underbrace{ω Ty ( t )}}_{Δ x} \qquad ( 2 )$$

$$y ( t ) - y ( t ) = {\underbrace{- \frac{1}{2} v ω {T}^{2} - ω Tx ( t )}}_{Δ y} \qquad ( 3 )$$

As illustrated in FIG. 5, in step S110, the CPU 11 associates the gradient of the stationary object calculated in step S100 with a radar device that has detected an observation point corresponding to the gradient of the stationary object (i.e., the radar device 3 or the radar device 4) and the observation angle θₘ(t) and stores them in the RAM 13, and terminates the gradient calculation process.

Next, a procedure of an angular correction process performed by the control unit 7 will be described. The angular correction process is performed every time a preset execution period (e.g., one hour) has elapsed while the control unit 7 operates. It is noted that the angular correction process is performed for each of the radar device 3 and the radar device 4. Hereinafter, a procedure of the angular correction process performed for the radar device 3 will be described. The angular correction process performed for the radar device 4 has a procedure similar to that of the angular correction process performed for the radar device 3.

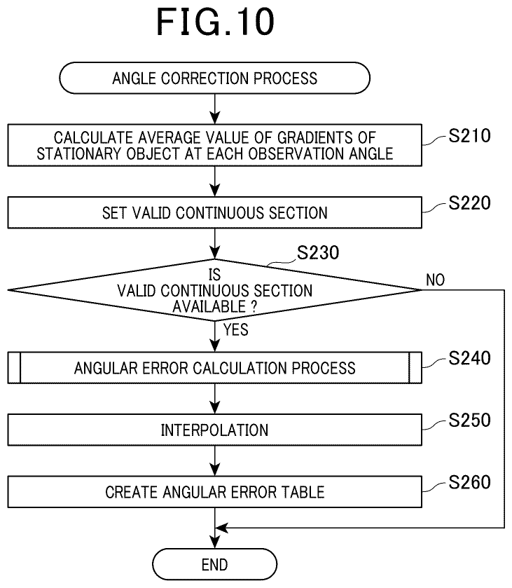

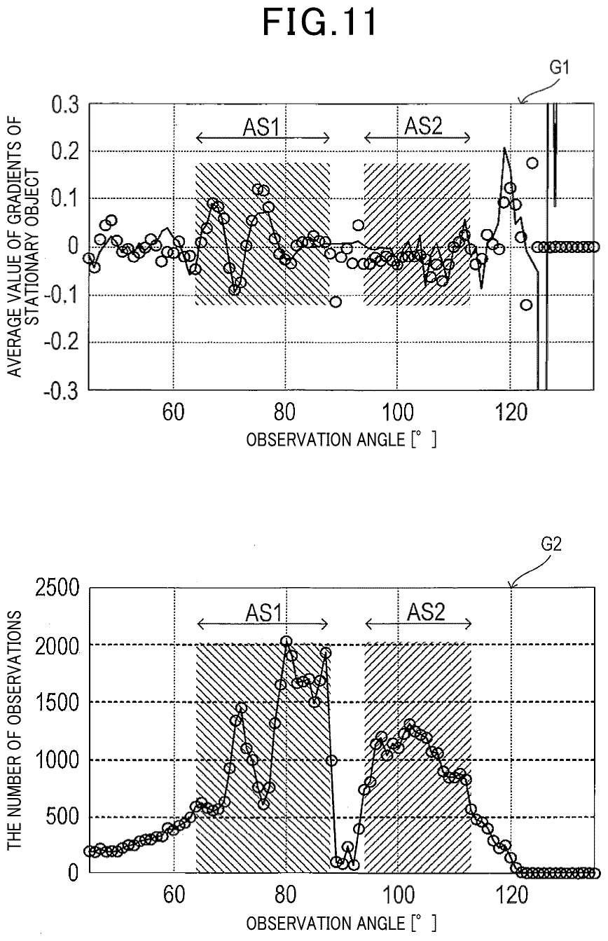

When the angular correction process is performed, as illustrated in FIG. 10, first in step S210, the CPU 11 of the control unit 7 calculates an average value of gradients of the stationary object at each observation angle. Specifically, the CPU 11 calculates an average value of a plurality of gradients of the stationary object, which are stored by the processing in step S110, at each observation angle, from the termination of the previous angular correction process to the start of the current angular correction process. For example, when N gradients of the stationary object at the observation angle θₘ is stored, the CPU 11 calculates a divided value obtained by dividing the sum of the N gradients of the stationary object by N as the average value of the gradients of the stationary object at the observation angle θₘ. A graph G1 in FIG. 11 illustrates an average value of gradients of the plurality of stationary objects observed by the radar device 3, at each observation angle.

As illustrated in FIG. 10, in step S220, the CPU 11 sets a valid continuous section. Specifically, the CPU 11 sets, as the valid continuous section, a range of the observation angle at which the number of observations is a preset valid determination value (e.g., 500) or larger. A graph G2 in FIG. 11 illustrates the number of observations for the plurality of stationary objects observed by the radar device 3, at each observation angle. In the graph G2, a valid continuous section AS1 of the radar device 3 is 64° to 88°. A valid continuous section AS2 of the radar device 3 is 94° to 113°.

As illustrated in FIG. 10, in step S230, the CPU 11 determines whether a valid continuous section is available. Specifically, the CPU 11 determines whether a section length of the valid continuous section is a preset valid continuous determination value (e.g., 10°) or longer. If the section length is the valid continuous determination value or longer, the CPU 11 determines that the valid continuous section is available.

If the valid continuous section is not available, the CPU 11 terminates the angular correction process. If the valid continuous section is available, in step S240, the CPU 11 performs an angular error calculation process.

Hereinafter, a fundamental principle of the angular error calculation process will be described.

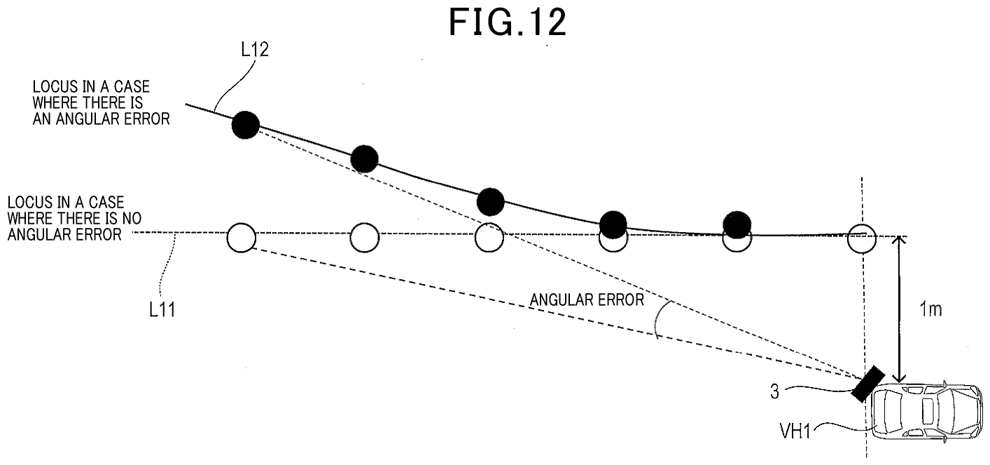

As illustrated in FIG. 12, in the angular error calculation process, when the own vehicle travels in a straight line, a locus is estimated of a stationary object, located 1 m from the lateral side of the own vehicle in the direction perpendicular to the traveling direction of the own vehicle.

When there is no angular error, since the own vehicle is traveling in a straight line, a lateral position of the stationary object is 1 m, which is constant, from the own vehicle, and the shape of the locus is a straight line as indicated by a broken line L11. However, in actuality, due to an angular error, the shape of the locus is not a straight line as indicated by a solid line L12.

In the angular error calculation process, comparing a locus predicted from a gradient of a movement locus of the stationary object with a movement locus obtained when there is no angular error calculates an angular error at each arbitrary angle. The broken line L11 corresponds to a reference movement locus L11 described later. The solid line L12 corresponds to an average movement locus L12 described later.

Next, a procedure of the angular error calculation process will be described.

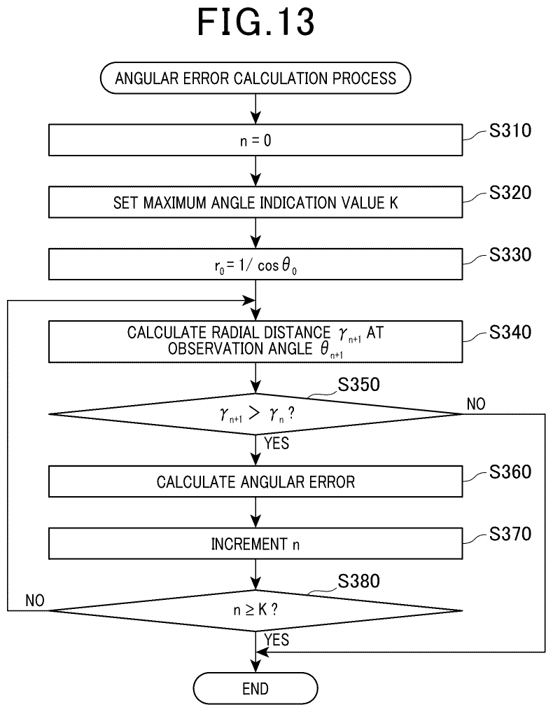

When the angular error calculation process is performed, as illustrated in FIG. 13, first in step S310, the CPU 11 of the control unit 7 sets a first angle indication value n provided to the RAM 13 to 0.

In step S320, the CPU 11 sets a first maximum angle indication value K. Specifically, the CPU 11 sets, as the first maximum angle indication value K, a subtraction value obtained by subtracting a value of a start angle of the valid continuous section from a value of an end angle of the valid continuous section. For example, since the valid continuous section AS1 is 64° to 88°, the first maximum angle indication value K is 24.

In step S330, the CPU 11 sets a radial distance r₀ at an angle θ₀ of the valid continuous section as (1/cosθ₀). That is, in the angular error calculation process, it is assumed that the angular error is 0 until the start angle of the valid continuous section.

In step S340, the CPU 11 calculates a radial distance rₙ₊₁ at an observation angle θₙ₊₁ using expression (4). In expression (4), α is an average value of gradients of the stationary object at an observation angle θₙ.

$${Γ}_{n + 1} = \frac{sin {θ}_{n} - α cos {θ}_{n}}{sin {θ}_{n + 1} - α cos {θ}_{n + 1}} {r}_{n} \qquad ( 4 )$$

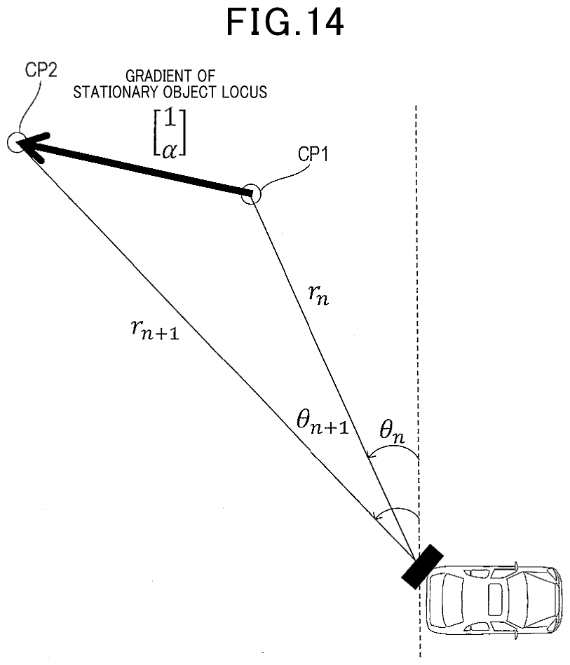

As illustrated in FIG. 14, expression (4) corresponds to calculating a point CP2 at which a line extending from a previously calculated CP1 at the gradient α of the stationary object intersects with a line extending in the direction at the observation angle θₙ₊₁.

As illustrated in FIG. 13, in step S350, the CPU 11 determines whether the radial distance rₙ₊₁ is longer than the radial distance rₙ. If the radial distance rₙ₊₁ is the radial distance In or shorter, the CPU 11 terminates the angular error calculation process.

In contrast, if the radial distance rₙ₊₁ is longer than the radial distance rₙ, in step S360, the CPU 11 calculates an angular error. Specifically, the CPU 11 calculates a true angle estimated value θₜᵣᵤₑ using expression (5), and further calculates, as an angular error, a subtraction value obtained by subtracting the true angle estimated value θₜᵣᵤₑ from the observation angle θₙ₊₁. Then, the CPU 11 associates the calculated angular error with the observation angle and stores them in the RAM 13.

$${θ}_{true} = {cos}^{- 1} ( \frac{1}{{r}_{n + 1}} ) \qquad ( 5 )$$

In step S370, the CPU 11 increments the first angle indication value n.

In step S380, the CPU 11 determines whether the first angle indication value n is the first maximum angle indication value K or larger. If the first angle indication value n is smaller than the first maximum angle indication value K, the CPU 11 proceeds to step S340. In contrast, if the first angle indication value n is the first maximum angle indication value K or larger, the CPU 11 terminates the angular error calculation process.

It is noted that, in FIG. 13, a procedure of calculating an angular error in one valid continuous section is illustrated. However, in the angular error calculation process in step S240, the CPU 11 performs processing of steps S310 to S380 for each of the valid continuous sections AS1, AS2 to calculate an angular error.

As illustrated in FIG. 10, if the angular error calculation process in step S240 is terminated, in step S250, the CPU 11 calculates an angular error of observation angles between the valid continuous section AS1 and the valid continuous section AS2 by interpolation. Specifically, the CPU 11 performs the interpolation by connecting an angular error of the maximum observation angle in the valid continuous section AS1 and an angular error of the minimum observation angle in the valid continuous section AS2 by a straight line, and calculates an angular error.

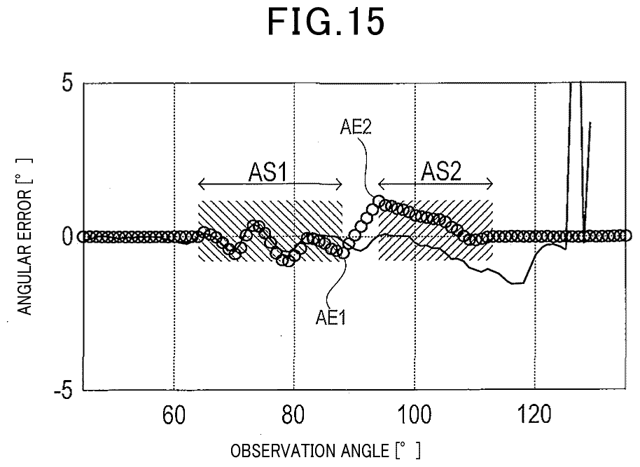

For example, as illustrated in FIG. 15, the CPU 11 connects an angular error AE1 of the maximum observation angle in the valid continuous section AS1 (i.e., 88°) and an angular error AE2 of the minimum observation angle in the valid continuous section AS2 (i.e., 94°) by a straight line to calculate angular errors at observation angles 89°, 90°, 91°, 92°, 93°.

When the processing in step S250 is terminated, as illustrated in FIG. 10, in step S260, the CPU 11 creates an angular error table and terminates the angular correction process. Specifically, first, the CPU 11 converts the observation angle to an angle centering on a central axis CA1 of the radar device 3 (hereinafter, radar observation angle).

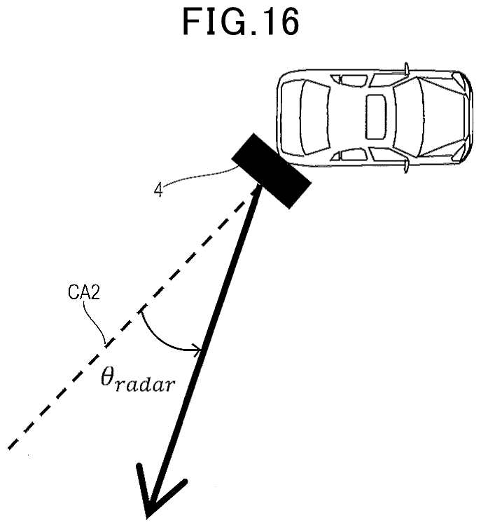

It is noted that in the processing of step S260 in the angular correction process performed for the radar device 4, the CPU 11 converts the observation angle to an angle centering on a central axis CA2 of the radar device 4 (hereinafter, radar observation angle). FIG. 16 indicates a radar observation angle θ_{radar} centering on the central axis CA2 of the radar device 4. That is, the observation angle in the valid continuous section of the radar device 3 is converted to an angle centering on the central axis CA1 of the radar device 3, and the observation angle in the valid continuous section of the radar device 4 is converted to an angle centering on the central axis CA2 of the radar device 4. Then, the CPU 11 sets angular errors corresponding to the respective plurality of radar observation angles to create the angular error table.

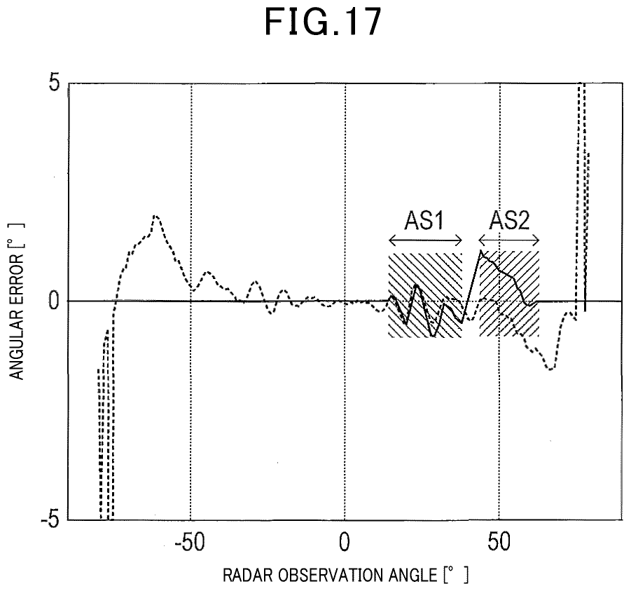

FIG. 17 is a graph illustrating a relationship between a radar observation angle and an angular error of the rear radar device 3. A solid line in the graph of FIG. 17 indicates an angular error calculated by the angular error calculation process. A broken line in the graph of FIG. 17 indicates a true value of the angular error.

Next, a procedure of a vehicular information provision process performed by the control unit 7 will be described. The vehicular information provision process is repeatedly performed while the control unit 7 operates.

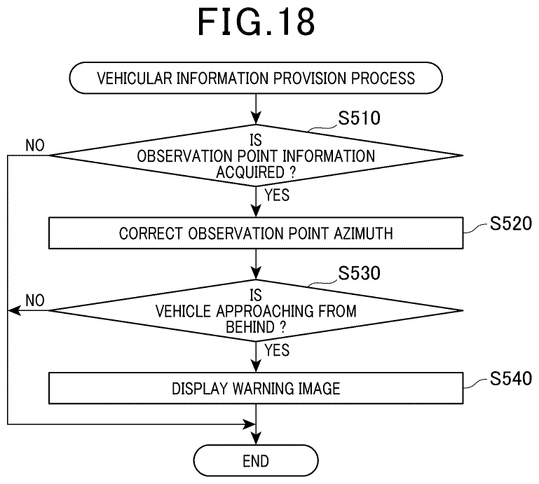

When the vehicular information provision process is performed, as illustrated in FIG. 18, first in step S510, the CPU 11 of the control unit 7 determines whether new observation point information has been acquired from the radar devices 3, 4. If no observation point information has been acquired, the CPU 11 terminates the vehicular information provision process. In contrast, if observation point information has been acquired, in step S520, the CPU 11 corrects an observation point azimuth angle indicated by the observation point information acquired in step S510 based on the angular error table created in step S260. That is, the CPU 11 specifies a radar observation angle corresponding to the observation point azimuth angle and extracts an angular error corresponding to the radar observation angle from the angular error table. Then, the CPU 11 adds the extracted angular error to the radar observation angle corresponding to the observation point azimuth angle to correct the observation point azimuth angle.

In step S530, the CPU 11 determines whether vehicles present in adjacent lanes on the left side and the right side of the own vehicle are approaching from behind the own vehicle, based on the observation point information acquired in step S510, the observation point azimuth angle corrected in step S520, and detection results of the vehicle speed sensor 5 and the yaw rate sensor 6.

If the vehicles present in the adjacent lanes on the left side and the right side of the own vehicle are not approaching from behind the own vehicle, the CPU 11 terminates the vehicular information provision process. In contrast, if the vehicles present in the adjacent lanes on the left side and the right side of the own vehicle are approaching from behind the own vehicle, in step S540, the CPU 11 causes the head-up display device 2 to display a warning image indicating that a vehicle is approaching from the rear left or the rear right, and terminates the vehicular information provision process.

The control unit 7 of the vehicular information provision device 1 configured as described above estimates an angular error that is an error of the azimuth angle detected by the radar devices 3, 4 installed in the own vehicle VH1.

The control unit 7 acquires observation point information including at least an observation point distance and an observation point azimuth angle that indicate a location of an object present in the vicinity of the own vehicle VH1, from the radar devices 3, 4 including lateral side areas of the own vehicle VH1 as the object detection areas R1, R2.

The control unit 7 acquires a vehicle speed detection signal and a yaw rate detection signal for specifying a movement locus of the own vehicle VH1.

The control unit 7 detects a stationary object, which is an object at rest in the lateral direction from the own vehicle VH1.

The control unit 7 calculates, for each of the detected plurality of stationary objects, a gradient of the stationary object indicating a moving direction of the stationary object viewed from the own vehicle VH1 assuming that the own vehicle VH1 is traveling in a straight line, for each observation angle at which the radar devices 3, 4 have observed the stationary object, based on the observation point information, the travelling speed detection signal, and the yaw rate detection signal.

The control unit 7 classifies the calculated plurality of gradients of the stationary object for each of the plurality of observation angles and calculates an average value of the plurality of gradients of the stationary object classified by the observation angle (hereinafter, referred to as a gradient average value) for each observation angle.

The control unit 7 calculates an angular error for each observation angle based on the movement locus L12 calculated based on the plurality of gradient average values calculated for respective observation angles (hereinafter, average movement locus L12) and the reference movement locus L11 set as a movement locus of the stationary object in a case in which there is no angular error.

Since the control unit 7 described above calculates an angular error for each observation angle based on the average movement locus L12 and the reference movement locus L11, accuracy in estimating an angular error in a case in which the own vehicle VH1 recedes from the stationary object can be suppressed from being reduced compared with a case in which an angular error is calculated based on change in speed with respect to change in an observation angle. Hence, the control unit 7 can improve the accuracy in estimating an angular error of the radar devices 3, 4.

In addition, if the number of the plurality of gradients of the stationary object classified by the observation angle (i.e., the number of observations) is the preset valid determination value or larger, the control unit 7 determines, for each of the plurality of observation angles, that the average value of gradients at the observation angle is valid and sets a valid continuous section in which observation angles at which the average value of gradients is valid are continuous. Furthermore, if the section length of the valid continuous section is the preset valid continuous determination value or longer, the control unit 7 calculates the average movement locus L12 based on the average values of gradients at the plurality of observation angles in the valid continuous section and calculates an angular error for each of the plurality of observation angles in the valid continuous section.

Since the control unit 7 described above calculates an angular error with average values of gradients obtained from a small number of observations being excluded, accuracy in estimating an angular error can be suppressed from being reduced.

In addition, if the travelling speed v of the own vehicle VH1 is the preset first gradient determination value or lower, the control unit 7 prohibits the calculation of a gradient of the stationary object. Hence, the control unit 7 can suppress an angular error from being calculated using a gradient of the stationary object having a large error, whereby accuracy in estimating an angular error can be suppressed from being reduced. This is because when the travelling speed v is low, a movement locus of the stationary object shortens, and an error of the gradient of the stationary object becomes large.

In addition, if the absolute value of the yaw rate o of the own vehicle VH1 is the preset second gradient determination value or larger, the control unit 7 prohibits the calculation of a gradient of the stationary object. Hence, the control unit 7 can suppress an angular error from being calculated using a gradient of the stationary object having a large error, whereby accuracy in estimating an angular error can be suppressed from being reduced. This is because when the yaw rate ω is high, a movement locus of the own vehicle VH1 due to turning is difficult to exactly cancel.

In addition, the object detection area R1 of the radar device 3 includes the left side object detection area R11 from which a stationary object present in the left lateral direction from the own vehicle VH1 is detected and the right side object detection area R13 from which a stationary object present in the right lateral direction from the own vehicle VH1 is detected.

The control unit 7 calculates an angular error for each observation angle corresponding to the left side object detection area R11 of the radar devices 3, 4 (i.e., an observation angle in the valid continuous section AS1). In addition, the control unit 7 calculates an angular error for each observation angle corresponding to the right side object detection area R13 of the radar devices 3, 4 (i.e., an observation angle in the valid continuous section AS2). The control unit 7 calculates an angular error between the observation angle corresponding to the left side object detection area R11 and the observation angle corresponding to the right side object detection area R13 by interpolation using an angular error of the observation angle corresponding to the left side object detection area R11 and an angular error of the observation angle corresponding to the right side object detection area R13. Hence, the control unit 7 can estimate an angular error in an angular range including an observation angle corresponding to the directly rearward direction of the own vehicle VH1.

In addition, the control unit 7 corrects an observation point azimuth angle detected by the radar devices 3, 4 by using an angular error. Hence, the control unit 7 can improve accuracy in position detection of the radar devices 3, 4.

In the embodiment described above, the control unit 7 corresponds to an angular error estimation device, the own vehicle VH1 corresponds to a movable body, step S10 corresponds to processing as a first information acquisition unit, the observation point distance and the observation point azimuth angle correspond to position information, and the observation point information corresponds to object detection information.

In addition, step S20 corresponds to processing as a second information acquisition unit, the travelling speed detection signal and the yaw rate detection signal correspond to movement locus information, step S30 corresponds to processing as a stationary object detection unit, step S100 corresponds to processing as a moving direction calculation unit, and a gradient of a stationary object corresponds to a moving direction indication value.

In addition, step S210 corresponds to processing as an average calculation unit, a gradient average value corresponds to a moving direction average value, and steps S220 to S240 correspond to processing as an angular error calculation unit.

In addition, step S80 corresponds to processing as a speed prohibition unit, a first gradient determination value corresponds to a speed prohibition determination value, step S90 corresponds to processing as a yaw rate prohibition unit, and a second gradient determination value corresponds to a yaw rate prohibition determination value.

In addition, the radar device 3 corresponds to a left side radar device, the radar device 4 corresponds to a right side radar device, step S250 corresponds to processing as an interpolation calculation unit, and step S520 corresponds to processing as an angular correction unit.

### Second Embodiment

Hereinafter, a second embodiment of the present disclosure will be described with reference to the drawings. It is noted that, in the second embodiment, parts different from those of the first embodiment will be described. Common components are denoted by the same reference signs.

The vehicular information provision device 1 of the second embodiment differs from that of the first embodiment in that the angular correction process is modified.

Next, a procedure of the angular correction process of the second embodiment will be described.

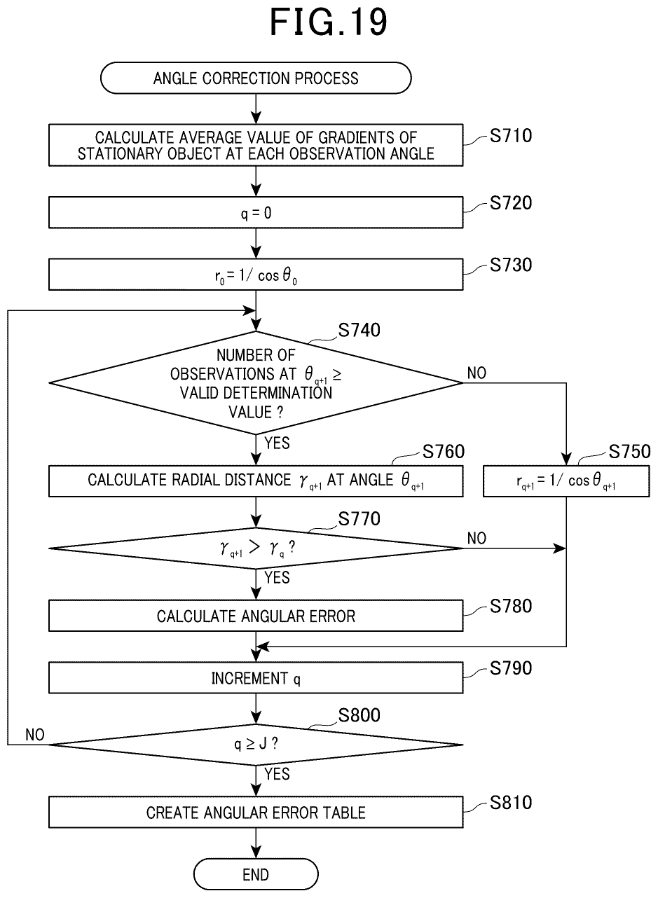

When the angular correction process of the second embodiment is performed, as illustrated in FIG. 19, first in step S710, the CPU 11 of the control unit 7 calculates an average value of gradients of the stationary object at each observation angle as in step S210.

In step S720, the CPU 11 sets a second angle indication value q provided to the RAM 13 to 0.

In step S730, the CPU 11 sets a radial distance r₀ at an angle ϕ₀ as (1/cosθ₀). The observation angle θ₀, θ₁, θ₂, . . . , θ₁₇₉, θ₁₈₀, are respectively correspond to b 0°, 1°₁, 2°, . . . , 179°, 180°.

In step S740, the CPU 11 determines whether the number of observations at an observation angle θ_{q+1} is a preset valid determination value (e.g., 500) of larger. If the number of observations at the observation angle θ_{q+1} is smaller than the valid determination value, in step S750, the CPU 11 sets a radial distance r_{q+1} at the observation angle θ_{q+1} as (1/cosθ_{q+1}) and proceeds to step S790. That is, the CPU 11 sets an angular error at the observation angle θ_{q+1} to 0.

In contrast, if the number of observations at the observation angle θ_{q+1} is the valid determination value or larger, in step S760, the CPU 11 calculates the radial distance r_{q+1} at the observation angle θ_{q+1} using expression (4) as in step S340.

In step S770, the CPU 11 determines whether the radial distance r_{q+1} is longer than the radial distance r_{q} as in step S350. If the radial distance r_{q+1} is the radial distance r_{q} or shorter, the CPU 11 proceeds to step S790.

In contrast, if the radial distance r_{q+1} is longer than the radial distance r_{q}, in step S780, the CPU 11 calculates an angular error as in step S360 and proceeds to step S790.

In S790, the CPU 11 increments the second angle indication value q.

In step S800, the CPU 11 determines whether the second angle indication value q is a second maximum angle indication value J (e.g., 180) or larger. If the second angle indication value q is smaller than the second maximum angle indication value J, the CPU 11 proceeds to step S740. In contrast, if the second angle indication value q is the second maximum angle indication value J or larger, in step S810, the CPU 11 creates an angular error table as in step S260, and terminates the angular correction process.

For each of the plurality of observation angles, if the number of a plurality of gradients of the stationary object classified by observation angle (i.e., the number of observations) is the preset valid determination value or larger, the control unit 7 of the vehicular information provision device 1 configured as described above determines that the gradient average value of the observation angles is valid and calculates the average movement locus L12, thereby calculating an angular error corresponding to the observation angle. According to the control unit 7 described above, since the angular error is calculated with gradient average values obtained from a small number of observations being excluded, accuracy in estimating an angular error can be suppressed from being reduced.

In the embodiment described above, step S710 corresponds to processing as an average calculation unit, the gradient average value corresponds to a moving direction average value, and steps S720 to S800 correspond to processing as an angular error calculation unit.

Although embodiments of the present disclosure have been described above, the present disclosure is not limited to the above embodiments and can be variously modified.

The control unit 7 and the processing thereof described in the present disclosure may be implemented by a dedicated computer which is provided by configuring a processor and a memory that are programmed to execute one or more functions embodied by a computer program. Alternatively, the control unit 7 and the processing thereof described in the present disclosure may be implemented by a dedicated computer which is provided by configuring a processor with one or more dedicated hardware logic circuits. Alternatively, the control unit 7 and the processing thereof described in the present disclosure may be implemented by one or more dedicated computers which are configured by combining a processor and a memory that are programmed to execute one or more functions, with a processor that is configured by one or more hardware logic circuits. Furthermore, the computer program may be stored in a computer readable non-transitory tangible storage medium, as instructions to be executed by a computer. The method implementing functions of parts included in the control unit 7 may not necessarily include software. All the functions may be implemented by using one or a plurality of hardware components.

A plurality of functions of a single component of the above embodiments may be implemented by a plurality of components. One function of one component may be implemented by a plurality of components. A plurality of functions of a plurality of components may be implemented by a single component. One function implemented by a plurality of components may be implemented by a single component. Furthermore, part of the configuration of the above embodiments may be omitted. Furthermore, at least part of the configuration of the above embodiments may be added to or replaced by another part of the configuration of the embodiments.

The present disclosure may be implemented by, in addition to the control unit 7 described above, various forms such as a system including the control unit 7 as a component, a program for causing a computer to function as the control unit 7, a non-transitory tangible storage medium such as a semiconductor memory storing the program, and an angular error estimation method.

### Technical Ideas Disclosed Herein

### Item 1

An angular error estimation device (7) that estimates an angular error that is an error of an azimuth angle detected by at least one radar device (3, 4) installed in a movable body (VH1), the angular error estimation device comprising:
a first information acquisition unit (S10) configured to acquire object detection information including at least position information indicating a position of an object present in the vicinity of the movable body, from the at least one radar device, including a lateral side of the movable body as an object detection area;
a second information acquisition unit (S20) configured to acquire movement locus information for specifying a movement locus of the movable body;
a stationary object detection unit (S30) configured to detect a stationary object that is at rest, and located at a lateral side of the movable body, based on the object detection information;
a moving direction calculation unit (S100) configured to calculate, for each of a plurality of stationary objects detected by the stationary object detection unit, a moving direction indication value indicating a moving direction of the stationary object viewed from the movable body assuming that the movable body is traveling in a straight line, for each observation angle at which the at least one radar device has observed the stationary object, based on the object detection information and the movement locus information;
an average calculation unit (S210, S710) configured to classify a plurality of moving direction indication values calculated by the moving direction calculation unit for each observation angle and calculate, as a moving direction average value, an average value of the plurality of moving direction indication values classified by the observation angle for each observation angle; and
an angular error calculation unit (S220 to S240, S720 to S800) configured to calculate the angular error for each of the observation angles based on an average movement locus calculated based on the plurality of moving direction average values for each of the observation angles and a reference movement locus set as a movement locus of the stationary object in a case in which there is no angular error.

### Item 2

The angular error estimation device according to item 1, wherein
for each of the plurality of observation angles, if the number of the plurality of moving direction indication values classified by observation angle is a preset valid determination value or larger, the angular error calculation unit (S720 to S800) determines that the moving direction average value of the observation angles is valid and calculates the average movement locus, thereby calculating the angular error corresponding to the observation angle.

### Item 3

The angular error estimation device according to item 1, wherein for each of the plurality of observation angles, if the number of the plurality of moving direction indication values classified by the observation angle is a preset valid determination value or larger, the angular error calculation unit (S220 to S240) determines that the moving direction average value of the observation angles is valid and sets a valid continuous section in which the observation angles at which the moving direction average value is valid are continuous, and if a section length of the valid continuous section is a preset valid continuous determination value or longer, the angular error calculation unit calculates the average movement locus based on the moving direction average value of the plurality of observation angles in the valid continuous section and calculates the angular error for each of the plurality of observation angles in the valid continuous section.

### Item 4

The angular error estimation device according to any one of items 1 to 3, further comprising a speed prohibition unit (S80) configured to prohibit calculation of the moving direction indication value by the moving direction calculation unit if a travelling speed of the movable body is a preset speed prohibition determination value or lower.

### Item 5

The angular error estimation device according to any one of items 1 to 4, further comprising a yaw rate prohibition unit (S90) configured to prohibit calculation of the moving direction indication value by the moving direction calculation unit if an absolute value of a yaw rate of the movable body is a preset yaw rate prohibition determination value or larger.

### Item 6

The angular error estimation device according to any one of items 1 to 5, wherein
the object detection area of the at least one radar device includes a left side object detection area from which the stationary object in a left lateral direction from the own vehicle is detected and a right side object detection area from which the stationary object in a right lateral direction from the own vehicle is detected,
the angular error calculation unit calculates the angular error for each of the observation angles corresponding to the left side object detection area and calculates the angular error for each of the observation angles corresponding to the right side object detection area, and
the angular error estimation device further comprises an interpolation calculation unit (S250) configured to calculate the angular error of the observation angle between the observation angle corresponding to the left side object detection area and the observation angle corresponding to the right side object detection area by interpolation using the angular error of the observation angle corresponding to the left side object detection area and the angular error of the observation angle corresponding to the right side object detection area.

### Item 7

The angular error estimation device according to any one of items 1 to 6, further comprising an angular correction unit (S520) configured to correct the azimuth angle detected by the at least one radar device by using the angular error.

### Item 8

An angular error estimation method performed by an angular error estimation device (7) that estimates an angular error that is an error of an azimuth angle detected by at least one radar device (3, 4) installed in a movable body (VH1), wherein
the angular error estimation device acquires object detection information including at least position information indicating a position of an object present in the vicinity of the movable body, from the at least one radar device, including a lateral side of the movable body as an object detection area;
the angular error estimation device acquires movement locus information for specifying a movement locus of the movable body;
the angular error estimation device detects a stationary object that is at rest, and located at a lateral side of the movable body, based on the object detection information;
the angular error estimation device calculates, for each of a detected plurality of stationary objects, a moving direction indication value indicating a moving direction of the stationary object viewed from the movable vehicle assuming that the movable vehicle is traveling in a straight line, for each observation angle at which the at least one radar device has observed the stationary object, based on the object detection information and the movement locus information;
the angular error estimation device classifies a calculated plurality of moving direction indication values for each observation angle and calculate, as a moving direction average value, an average value of the plurality of moving direction indication values classified by the observation angle for each observation angle; and
the angular error estimation device calculates the angular error for each of the observation angles based on an average movement locus calculated based on the plurality of moving direction average values for each of the observation angles and a reference movement locus set as a movement locus of the stationary object in a case in which there is no angular error.

An aspect of the present disclosure provides an angular error estimation device (7) that estimates an angular error that is an error of an azimuth angle detected by at least one radar device (3, 4) installed in a movable body (VH1)

The angular error estimation device of the present disclosure includes a first information acquisition unit, a second information acquisition unit, a stationary object detection unit, a moving direction calculation unit, an average calculation unit, and an angular error calculation unit.

The first information acquisition unit (S10) is configured to acquire object detection information including at least position information indicating a position of an object present in the vicinity of the movable body, from the at least one radar device, including a lateral side of the movable body as an object detection area.

The second information acquisition unit (S20) is configured to acquire movement locus information for specifying a movement locus of the movable body

The stationary object detection unit is configured to detect a stationary object that is at rest, and located at a lateral side of the movable body, based on the object detection information.

The moving direction calculation unit (S100) is configured to calculate, for each of a plurality of stationary objects detected by the stationary object detection unit, a moving direction indication value indicating a moving direction of the stationary object viewed from the movable body assuming that the movable body is traveling in a straight line, for each observation angle at which the at least one radar device has observed the stationary object, based on the object detection information and the movement locus information.

The average calculation unit (S210, S710) is configured to classify a plurality of moving direction indication values calculated by the moving direction calculation unit for each observation angle and calculate, as a moving direction average value, an average value of the plurality of moving direction indication values classified by the observation angle for each observation angle.

The angular error calculation unit (S220 to S240, S720 to S800) configured to calculate the angular error for each of the observation angles based on an average movement locus calculated based on the plurality of moving direction average values for each of the observation angles and a reference movement locus set as a movement locus of the stationary object in a case in which there is no angular error.

Since the angular error estimation device of the present disclosure described above calculates an angular error for each observation angle based on the average movement locus and the reference movement locus, accuracy in estimating an angular error in a case in which the vehicle recedes from the stationary object can be suppressed from being reduced compared with a case in which an angular error is calculated based on change in speed with respect to change in an observation angle. Hence, the angular error estimation device of the present disclosure can improve the accuracy in estimating an angular error of the radar device.

Another aspect of the present disclosure provides an angular error estimation method performed by an angular error estimation device (7) that estimates an angular error that is an error of an azimuth angle detected by at least one radar device (3, 4) installed in a movable body (VH1).

According to the angular error estimation method of the present disclosure, the angular error estimation device acquires object detection information including at least position information indicating a position of an object present in the vicinity of the movable body, from the at least one radar device including a lateral side of the movable body as an object detection area.

According to the angular error estimation method of the present disclosure, the angular error estimation device acquires movement locus information for specifying a movement locus of the movable body.

According to the angular error estimation method of the present disclosure, the angular error estimation device detects a stationary object that is at rest, and located at a lateral side of the movable body, based on the object detection information

According to the angular error estimation method of the present disclosure, the angular error estimation device calculates, for each of a detected plurality of stationary objects, a moving direction indication value indicating a moving direction of the stationary object viewed from the movable vehicle assuming that the movable vehicle is traveling in a straight line, for each observation angle at which the at least one radar device has observed the stationary object, based on the object detection information and the movement locus information

According to the angular error estimation method of the present disclosure, the angular error estimation device classifies a calculated plurality of moving direction indication values for each observation angle and calculate, as a moving direction average value, an average value of the plurality of moving direction indication values classified by the observation angle for each observation angle

According to the angular error estimation method of the present disclosure, the angular error estimation device calculates the angular error for each of the observation angles based on an average movement locus calculated based on the plurality of moving direction average values for each of the observation angles and a reference movement locus set as a movement locus of the stationary object in a case in which there is no angular error.

The angular error estimation method of the present disclosure is a method performed by the angular error estimation device of the present disclosure. Performing the method can obtain effects similar to those of the angular error estimation device of the present disclosure.

What is claimed is:

1. An angular error estimation device that estimates an angular error that is an error of an azimuth angle detected by at least one radar device installed in a movable body, the angular error estimation device comprising:
a first information acquisition unit configured to acquire object detection information including at least position information indicating a position of an object present in the vicinity of the movable body, from the at least one radar device, including a lateral side of the movable body as an object detection area;
a second information acquisition unit configured to acquire movement locus information for specifying a movement locus of the movable body;
a stationary object detection unit configured to detect a stationary object that is at rest, and located at a lateral side of the movable body, based on the object detection information;
a moving direction calculation unit configured to calculate, for each of a plurality of stationary objects detected by the stationary object detection unit, a moving direction indication value indicating a moving direction of the stationary object viewed from the movable body assuming that the movable body is traveling in a straight line, for each observation angle at which the at least one radar device has observed the stationary object, based on the object detection information and the movement locus information;
an average calculation unit configured to classify a plurality of moving direction indication values calculated by the moving direction calculation unit for each observation angle and calculate, as a moving direction average value, an average value of the plurality of moving direction indication values classified by the observation angle for each observation angle; and
an angular error calculation unit configured to calculate the angular error for each of the observation angles based on an average movement locus calculated based on the plurality of moving direction average values for each of the observation angles and a reference movement locus set as a movement locus of the stationary object in a case in which there is no angular error.

2. The angular error estimation device according to claim 1, wherein
for each of the plurality of observation angles, if the number of the plurality of moving direction indication values classified by observation angle is a preset valid determination value or larger, the angular error calculation unit determines that the moving direction average value of the observation angles is valid and calculates the average movement locus, thereby calculating the angular error corresponding to the observation angle.

3. The angular error estimation device according to claim 1, wherein
for each of the plurality of observation angles, if the number of the plurality of moving direction indication values classified by the observation angle is a preset valid determination value or larger, the angular error calculation unit determines that the moving direction average value of the observation angles is valid and sets a valid continuous section in which the observation angles at which the moving direction average value is valid are continuous, and
if a section length of the valid continuous section is a preset valid continuous determination value or longer, the angular error calculation unit calculates the average movement locus based on the moving direction average value of the plurality of observation angles in the valid continuous section and calculates the angular error for each of the plurality of observation angles in the valid continuous section.

4. The angular error estimation device according to claim 1, further comprising a speed prohibition unit configured to prohibit calculation of the moving direction indication value by the moving direction calculation unit if a travelling speed of the movable body is a preset speed prohibition determination value or lower.

5. The angular error estimation device according to claim 1, further comprising a yaw rate prohibition unit configured to prohibit calculation of the moving direction indication value by the moving direction calculation unit if an absolute value of a yaw rate of the movable body is a preset yaw rate prohibition determination value or larger.

6. The angular error estimation device according to claim 1, wherein
the object detection area of the at least one radar device includes a left side object detection area from which the stationary object in a left lateral direction from the own vehicle is detected and a right side object detection area from which the stationary object in a right lateral direction from the own vehicle is detected,
the angular error calculation unit calculates the angular error for each of the observation angles corresponding to the left side object detection area and calculates the angular error for each of the observation angles corresponding to the right side object detection area, and
the angular error estimation device further comprises an interpolation calculation unit configured to calculate the angular error of the observation angle between the observation angle corresponding to the left side object detection area and the observation angle corresponding to the right side object detection area by interpolation using the angular error of the observation angle corresponding to the left side object detection area and the angular error of the observation angle corresponding to the right side object detection area.

7. The angular error estimation device according to claim 1, further comprising an angular correction unit configured to correct the azimuth angle detected by the at least one radar device by using the angular error.

8. An angular error estimation method performed by an angular error estimation device that estimates an angular error that is an error of an azimuth angle detected by at least one radar device installed in a movable body, wherein
the angular error estimation device acquires object detection information including at least position information indicating a position of an object present in the vicinity of the movable body, from the at least one radar device, including a lateral side of the movable body as an object detection area;
the angular error estimation device acquires movement locus information for specifying a movement locus of the movable body;
the angular error estimation device detects a stationary object that is at rest, and located at a lateral side of the movable body, based on the object detection information;
the angular error estimation device calculates, for each of a detected plurality of stationary objects, a moving direction indication value indicating a moving direction of the stationary object viewed from the movable vehicle assuming that the movable vehicle is traveling in a straight line, for each observation angle at which the at least one radar device has observed the stationary object, based on the object detection information and the movement locus information;
the angular error estimation device classifies a calculated plurality of moving direction indication values for each observation angle and calculate, as a moving direction average value, an average value of the plurality of moving direction indication values classified by the observation angle for each observation angle; and
the angular error estimation device calculates the angular error for each of the observation angles based on an average movement locus calculated based on the plurality of moving direction average values for each of the observation angles and a reference movement locus set as a movement locus of the stationary object in a case in which there is no angular error.
